(19) United States
(12) Patent Application Publication
(10) Pub. No.: US 2008/0005353 A1
(43) Pub. Date: Jan. 3, 2008

(54) Enabling a plurality of devices to control each other

(75) Inventors: Ruston Panabaker, Bellevue, WA (US); Steven J. Ball, Seattle, WA (US); Vladimir Sadovsky, Bellevue, WA (US); Joseph Matthews, Woodinville, WA (US)

Correspondence Address: MICROSOFT CORPORATION, ONE MICROSOFT WAY, REDMOND, WA, 98052-6399, US

(73) Assignees: Microsoft Corporation, Redmond, WA (US); Microsoft Patent Group

(21) Appl. No.: 11/478,172

(22) Filed: Jun. 28, 2006

(51) Int. Cl. G06F 15/173

(52) U.S. Cl. 709/238; 710/100

(57) ABSTRACT

A technology for enabling a plurality of devices to control each other is disclosed. In one method approach, a constellation is created by associating a plurality of devices with each other. At least one device that is associated with the constellation is used to control an activity associated with at least one other device that is associated with the constellation.

### BACKGROUND

As electronic technology advances, people are buying more and more different kinds of electronic devices, such as digital televisions, personal computers (PCs), portable media players (PMPs), cell phones, and stereos. Different devices have different capabilities. For example, some of these devices are capable of listening to audio media. Others are capable of looking at or watching visual media. Yet others are capable of listening to and watching audio visual media. Other examples of activities that devices may or may not be capable of include storing, managing, playing, and rendering media.

### SUMMARY

This Summary is provided to introduce concepts concerning enabling a plurality of devices to control each other which are further described below in the Detailed Description. This Summary is not intended to identify key features or essential features of the claimed subject matter, nor is it intended to be used as an aid in determining the scope of the claimed subject matter.

A technology for enabling a plurality of devices to control each other is disclosed. In one method approach, a constellation is created by associating a plurality of devices with each other. At least one device that is associated with the constellation is used to control an activity associated with at least one other device that is associated with the constellation.

### DESCRIPTION OF THE DRAWINGS

The accompanying drawings, which are incorporated in and form a part of this specification, illustrate embodiments of the technology for enabling a plurality of devices to control each other and, together with the description, serve to explain principles discussed below:

FIG. 1 depicts a system that enables a plurality of devices to control each other, according to one embodiment.

FIG. 2 depicts a system that includes a plurality of devices associated with a constellation, according to one embodiment.

FIG. 3 depicts a system that includes a plurality of devices associated with a constellation, according to another embodiment.

FIG. 4 is a block diagram of a system that includes protocol stacks based on the open system interconnection (OSI) model on the transmitting side and on the receiving side, according to one embodiment.

FIG. 5 depicts a block diagram of a system that uses one device to bridge communications between two other devices that use different protocols, according to one embodiment.

FIG. 6 illustrates an exemplary computer system used in accordance with embodiments of the present technology for enabling a plurality of devices to control each other.

FIGS. 7 and 8 are flowcharts for methods of enabling a plurality of devices to control each other, according to various embodiments.

The drawings referred to in this description should be understood as not being drawn to scale except if specifically noted.

### DETAILED DESCRIPTION

Reference will now be made in detail to embodiments of the present technology for enabling a plurality of devices to control each other, examples of which are illustrated in the accompanying drawings. While the technology for enabling a plurality of devices to control each other will be described in conjunction with various embodiments, it will be understood that they are not intended to limit the present technology for enabling a plurality of devices to control each other to these embodiments. On the contrary, the presented technology for enabling a plurality of devices to control each other is intended to cover alternatives, modifications and equivalents, which may be included within the spirit and scope the various embodiments as defined by the appended claims. Furthermore, in the following detailed description, numerous specific details are set forth in order to provide a thorough understanding of the present technology for enabling a plurality of devices to control each other. However, the present technology for enabling a plurality of devices to control each other may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “creating,” “using,” “enabling,” “transmitting,” “receiving,” “providing,” “authorizing,” “discovering,” “communicating,” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology for enabling a plurality of devices to control each other is also well suited to the use of other computer systems such as, for example, optical and mechanical computers. Additionally, it should be understood that in embodiments of the present technology for enabling a plurality of devices to control each other, one or more of the steps can be performed manually.

### Overview

According to one embodiment, methods and systems that enable a plurality of devices to control each other are provided. According to various embodiments, using one device to control one or more other devices is a seamless experience for a user. For example, using a personal computer to “interact with” media is often complex and task intensive for a user. Examples of “interacting with” media include, among other things, accessing media, seeing visual media, listening to audio media, and listening to, watching audio visual media, and managing media.

As portable media players, such as iPODS™, become more popular, there is a growing need for simpler methods to access and play media on PCs when PMPs containing vast amounts of media are connected to each other. According to one embodiment, the user can use an interface on their PMP to control the media experience on the PC and vice versa. Also, the user may be able to use transport control on their PMP to control the media experience on the PC and vice versa. In fact, according to one embodiment, a user is allowed to control a plurality of devices that belong for example to a “constellation and to transfer media between the plurality of devices associated with the constellation.

Further, according to yet another embodiment, the user has a simple integrated experience. For example, the user can choose music or video on the PMP and then have the media played on the PC's speakers and display. The user can then hit pause on a third device associated with the constellation and have the media paused. The user could then select a video on the third device and have the media also played back on the PC and show metadata, such as titles and artists of the media, on the PMP, for example. This simple intuitive interface makes it easy for a user to control how they experience the media regardless of what they are doing on the PC and regardless of where the media is. This will also provide a compelling way to control media consumption because a user can sit on their couch with their PMP and choose media to play on their large display with their best sound system. According to one embodiment, the controls on which ever device the user is currently using extend to control the media streams on other devices that are part of the current constellation. For example, as a user moves between devices and/or locations associated with a constellation, the control points can be moved intelligently to reflect where the user is in relationship to the devices.

### A System That Enables a Plurality of Devices to Control Each Other

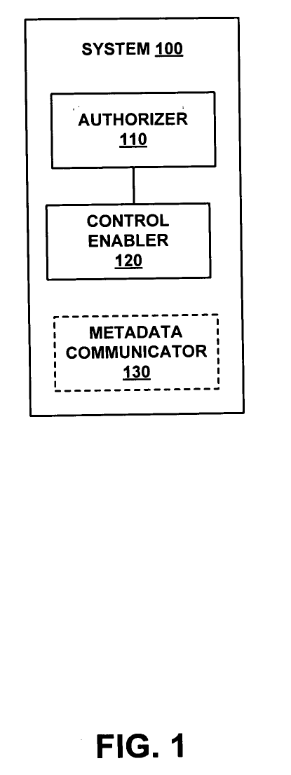

FIG. 1 depicts a system that enables a plurality of devices to control each other, according to one embodiment. For example, system 100 could be installed on the devices that a user would like to become a part of a constellation. System 100, as depicted in FIG. 1, includes an authorizer 110, a control enabler 120, and an optional metadata communicator 130. A device that includes a system 100 can use the authorizer 110 to authorize other devices to join a constellation. A device that includes system 100 can use the control enabler 120 to control other devices associated with the constellation. According to one embodiment, devices associated with a constellation connect with each other in order to control each other, as will become more evident.

### Constellations

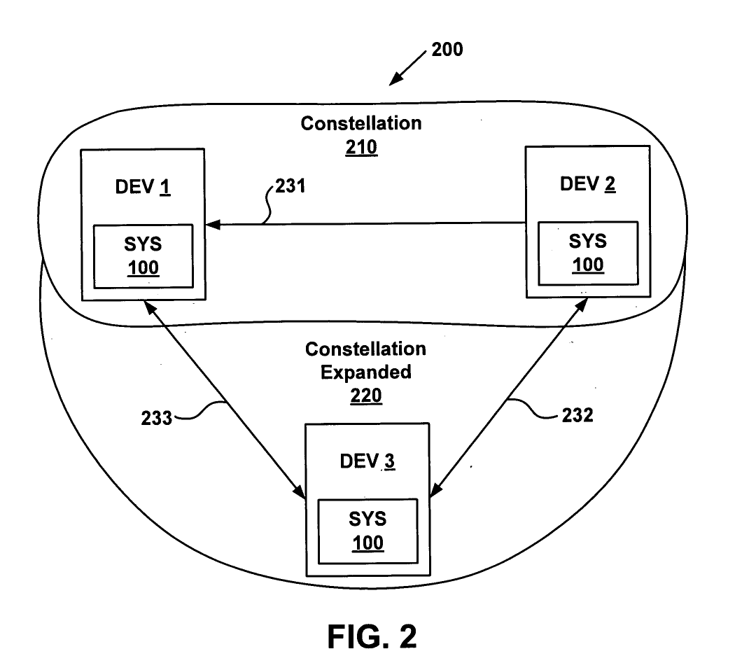

FIGS. 2, 3 and 5 depict various examples of constellations that include a plurality of devices. FIG. 2 depicts a system 200 that includes a plurality of devices associated with a constellation, according to one embodiment. A device that is associated with a constellation can be any kind of electronic device that is capable of controlling another electronic device or that is capable of being controlled by another device. Examples of devices that can be associated with a constellation include but are not limited to a computer, a television, a portable media player, a phone, a stereo, a keyboard, a wireless remote control, a wired game controller, a light switch, a wall-mounted keyboard, a car radio, a DVD player, an audio/video receiver, and a headset. According to one embodiment, a DVD player is a type of stereo. For the purposes of illustrating FIG. 2, assume device 1 is a digital TV that includes Window's media player™, device 2 is a cell phone, and device 3 is a portable media player, such as an iPOD™.

According to one embodiment, each of the devices 1, 2, and 3 includes a system 100 as depicted in FIG. 1. According to one embodiment, the constellation 210 includes two devices 1 and 2. The constellation 210 could initially include one device, such as device 1. Then device 2 could send a request as indicated by line 231 to device 1's authorizer 110. For the sake of illustration assume that device 1's authorizer 110 authorizes device 2 to join the constellation. Alternatively, device 2 could be the first device to be associated with the constellation and device 2 could authorize device 1 to join the constellation.

FIG. 2 depicts the constellation 210 at the point where device 1 and device 2 are associated with the constellation 210. According to one embodiment, device 1 is enabled to control device 2 and according to another embodiment, device 2 is enabled to control device 1.

Assume for the sake of illustration that the user decides they want device 3 to join the constellation 210. The user can cause device 3 to send a request as indicated by line 232 to device 2's authorizer 110. Assume for the sake of illustration that device 2's authorizer 110 authorizes device 3 to join the constellation 210 and therefore the constellation 210 is expanded 220 to include device 3. Then the user may decide that they want to use device 3 to control device 1 in some manner. In this case, for example, device 3 can connect with device 1 as indicated by line 233. Assume for the sake of illustration that device 1 does not have any information indicating that device 3 belongs to the constellation. According to one embodiment, device 1 can ask the other devices, such as device 2, which belong to the constellation whether they have information indicating device 3 has been previously authorized. In this case, device 2 can respond indicating that it has previously authorized device 3. Then, according to one embodiment, device 1 can allow device 3 to control it (i.e., device 1) in some respect.

According to another embodiment, any device associated with the constellation 210 can control any other device associated with the constellation 210. For example, device 1 can control devices 2 and 3, device 2 can control devices 1 and 3, and device 3 can control devices 1 and 2.

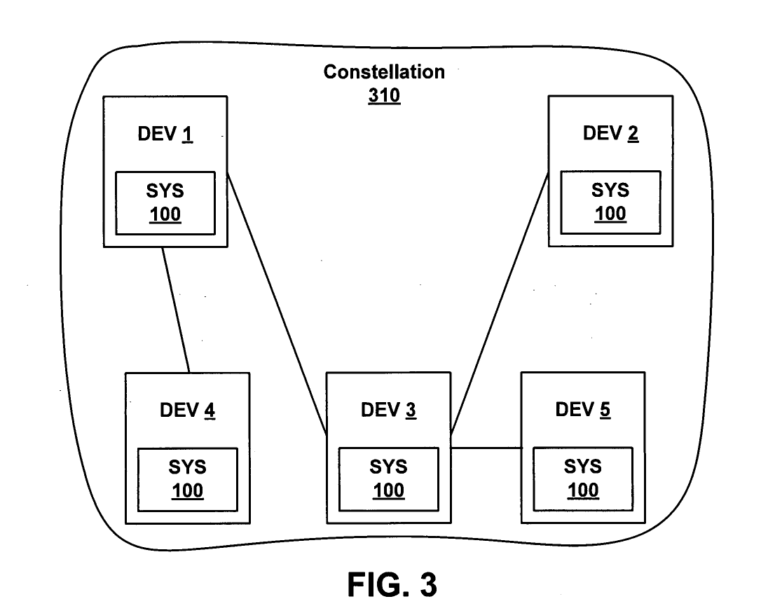

FIG. 3 depicts a system with a plurality of devices associated with a constellation, according to another embodiment. As depicted in FIG. 3, the constellation 310 includes devices 1-5. The lines between the devices indicate which devices have been authorized to each other. As already stated, if a device is authorized by one device associated with a constellation, the authorized device is associated with the constellation, according to one embodiment. As depicted in FIG. 3, device 1 has authorized device 4 or vice versa, device 1 has authorized device 3 or vice versa, device 3 has authorized device 2 or vice versa, and device 3 has authorized device 5 or vice versa.

### Authorizing

An authorizer associated with a device maintains a list of what devices it has authorized, according to one embodiment. For example, referring to FIG. 3 an authorizer associated with device 1 could maintain a list that indicates devices 3 and 4 were authorized by device 1. In another example, an authorizer associated with device 4 can maintain a list that indicates device 1 was authorized by device 4. In another example, the authorizer associated with device 3 could maintain a list that indicates device 1, 2 and 5 were authorized by device 3. In yet another example, device 2 could maintain a list indicating that device 3 was authorized by device 2 and so on with each of the devices depicted in FIG. 3.

According to one embodiment, a hierarchy of controls can be used. For example, one device may be authorized to control another device but not vice versa.

According to one embodiment, the systems 100 associated with devices in a constellation are capable of communicating information about a first device to a third device, where a second device has authorized the first device. For example referring to FIG. 3, assume for the sake of illustration, that device 1 has authorized device 3 then device 3 attempts to communicate with device 4. In this case, device 4 can ask device 1 whether it has any knowledge of whether device 3 has been previously authorized. Since, in this illustration, device 1 had previously authorized device 3, device 1 can communicate to device 4 that device 3 has been authorized to join the constellation. According to one embodiment, device 4 can add device 3 to the list of authorized devices that it (device 4) maintains.

According to one embodiment, a request for information about a device can be transmitted through one or more intermediate devices that are associated with the constellation. According to one embodiment, the information that is transmitted through intermediate devices indicates whether a device has been authorized to join the constellation. For example, referring to FIG. 3 assume that device 5 attempts to communicate with device 4 but device 4 has no information about device 5. In this case, device 4 can request information about device 5 from devices that device 4 has in its list of authorized devices. As depicted in FIG. 3, device 1 is in device 4's list because device 4 authorized device 1 or vice versa. Based on FIG. 3, device 1 also does not have information about device 5. So device 1 will request information about device 5 from device 3. Device 3 does have information about device 5 because device 3 authorized device 5 to the constellation, for example. Device 3 can communicate information about device 5 to device 1 and device 1 can in turn communicate information about device 5 to device 4.

According to one embodiment, the information that is communicated from device 3 to device 4 through the intermediary device 1 indicates that device 3 has authorized device 5 to join the constellation 310. Similar processing can be performed in the event that devices 3 and 4 attempt to communicate, devices 2 and 4 attempt to communicate, devices 2 and 5 attempt to communicate, devices 1 and 5 attempt to communicate, among other things.

Referring to FIG. 3, devices 3 and 4 are examples of trusted partners of device 1, for example, because devices 4 and 3 have been authorized to device 1 as indicated by the lines between device 1 and device 3 and 4. Devices 2 and 5 are examples of potential partners of device 1 because for example, device 1 may receive information indicating that devices 2 and 5 have joined the constellation 310 through device 3.

According to another embodiment, a centralized server model is used for maintaining what devices have been authorized. For example, a list of all of the devices associated with a constellation may be maintained on a centralized server.

A device is re-authorized each time the device requests to control another device associated with a constellation, according to one embodiment. For example, referring to FIG. 2, the authorizer 110 associated with device 2 authorizes device 3 to join the constellation 210. After device 3 has finished engaging in some activity to control another device, such as device 1 or device 2, device 3's authorization is removed. If device 3 attempts to control device 1 or 2 in the future, device 3 will have to be re-authorized by at least one of the devices associated with the constellation 210. According to one embodiment, a device can leave the constellation, for example, by being physically disconnected or by being logically disconnected either by the device itself or by the device that authorized it.

A device is perpetually authorized after the device has been authorized to join the constellation, according to another embodiment. For example, referring to FIG. 2, the authorizer 110 associated with device 2 can authorize device 3 to join the constellation 210 and thereafter device 3 is always a part of the constellation.

Authorization of a device can be performed as a result of a user causing the authorization to be performed, according to one embodiment. For example, a user of device 2 may interact with device 2 to cause it to authorize device 3. Alternatively authorization of a device can be performed automatically by a device. For example, device 2 may be “self-aware” and discover device 3. As a result, device 2 may automatically authorize device 3 after device 2 has discovered device 3.

### Media

Examples of media include visual media that can be seen, audio media that can be heard, and audio visual media that can be seen and heard. Examples of visual media include digital pictures. Examples of audio media include music, recorded events, voice recordings, and streaming or previously recorded audio media. Examples of audio media include videos. Media may be pre-recorded or real-time.

One device associated with a constellation can be used to access media associated with another device that is also associated with the constellation, according to one embodiment. For example, assume that a PC and an iPOD™ are associated with a constellation. The PC can access music that is on the iPOD™ and cause the iPOD™ to play the music or vice versa.

Media can be transmitted from, one device to another device, according to another embodiment. For example, media stored on an iPOD™ can be transmitted to a PC or vice versa. Further, media can be transmitted through intermediaries. For example referring to FIG. 3, media could be transmitted from device 2 to device 3 to device 1 to device 4. In this example, devices 1 and 3 are examples of intermediaries between devices 2 and 4.

### Metadata

Examples of metadata include descriptions, such as titles of media, artists of the media, and a device's capabilities. According to one embodiment, a system 100 also includes a metadata communicator 130.

Metadata can be communicated from one device to another device associated with a constellation. For example referring to FIG. 2, device 2's metadata can be transferred from device 2 to device 1. In another example, referring to FIG. 3 metadata could be transmitted from device 2 to device 3 to device 1 to device 4.

According to one embodiment, all of a device's metadata is communicated to another device associated with a constellation. According to another embodiment, part of a device's metadata is communicated with another device associated with the constellation.

One device can navigate metadata associated with another device associated with a constellation, according to one embodiment. For example, referring to FIG. 2 assume that device 2's metadata is stored on device 2. A user can use device 1 to navigate the metadata stored on device 2. In another example, referring to FIG. 3 device 4 could navigate metadata on device 1 or device 3 or device 2 or device 5 using intermediary devices 1, 2, and 3 as described herein.

### Control

According to one embodiment, at least one device that is associated with a constellation can control an activity associated with at least one other device that is associated with the constellation. For example, the keypad on a cell phone could be used to cause a stereo to play music.

According to one embodiment, a constellation control protocol that includes a set of controls enables devices associated with a constellation to implement a different subset of the set of controls. For example, a set of controls, according to one embodiment, includes play, pause, stop, sync, next media, skip media, shuffle media, fast forward, rewind, increase volume and decrease volume. The set of controls, according to one embodiment, is used to control activities on a device. For example, the play control can be used to cause a device to engage in the activity of playing media.

According to one embodiment, each device associated with a constellation implements a subset of the controls. For example, a cell phone may implement the play, fast forward, rewind, increase volume and decrease volume controls. A subset of the controls, according to one embodiment, is defined as one or more of the controls associated with the set of controls. A subset of the controls can include all of the controls from the set of controls. Therefore in another example, a PC may implement all of the controls in the set of controls.

A subset of controls for a particular device is based upon the particular device's capabilities and on how the manufacturer chose to implement the particular device, according to one embodiment. For example, since a typical phone does not store media on itself the typically phone would not be capable of playing media that is stored on itself. However, the phone can still be used to control another device, for example, using the phone's keypad. In another example, a manufacture of a device can choose to implement a certain subset of the controls. For example, a manufacturer of device may implement the play, pause, and stop controls but not the next, skip and shuffle. In another example, a manufacturer may implement their device to play media on a competitor's device. In yet another example, a manufacturer may implement their device to only play media on a big screen television. In still another example, a device may be implemented to control metadata, by navigating the metadata, transferring, or intelligently combing the metadata between devices for example, but not to control media.

According to one embodiment, metadata can be intelligently re-formatted for example when metadata is communicated between two devices that do not share a common metadata format.

According to one embodiment, a new control can be added to the subset of controls that the particular device is capable of. For example, a device A may be upgraded by installing new software onto the device A that enables the device A to have a control that it did not previously have.

A device is not required to store media on it in order to be able to control another device. For example, a phone typically would not be used to store media. However, the phone could be used to cause media to be played, fast forwarded, rewound, among other things, on a digital television, a PC, or an iPOD™, for example.

According to one embodiment, the keypad associated with a phone can be used in an intuitive way to control activities on another device. For example, the keys on a key pad can be mapped in an intuitive way to control activities. In a specific example, key 1 may be play, key 2 may be increase volume, key 8 may be decrease volume, key 4 may be rewind, and key 6 may be fast forward. According to one embodiment, a keyboard is a type of keypad.

### A Device's Capabilities

Examples of a device's capabilities include whether the device can store media, display visual media, play audio media, display and play audio visual media, and so on. Other examples of a device's capabilities include what activities the device is capable of controlling using the subset of the controls the device implements. For example, a device's capabilities can include what subset of the controls the device implements.

According to one embodiment, one device can discover the capabilities of another device. For example, referring to FIG. 2 device 1 may discover device 2's capabilities when device 1 authorized device 2 to join the constellation.

A device's capabilities can be communicated to other devices, according to another embodiment. For example, referring to FIG. 3 device 3 could communicate its device capabilities to device 1 when device 1 authorized device 3 to join the constellation.

According to another embodiment, a request for information about a device can be transmitted through one or more intermediate devices that are associated with the constellation. According to one embodiment, the information that is transmitted through the intermediaries includes a device's capabilities. For example, referring FIG. 3 device 3 could provide device 5's capabilities to device 1 which could in turn provide device 5's capabilities to device 4.

As already stated, according to one embodiment, a new control can be added to the subset of controls that the particular device is capable of. In this case, the devices associated with a constellation can use various embodiments described herein to inform the devices associated with the constellation of device A's new capabilities.

According to one embodiment, one device may have the ability to broadcast electronic data, such as media, a device's capabilities, state information, etc. to the other devices that are associated with a constellation.

### Protocols

According to one embodiment, the plurality of devices in a constellation use various protocols to provide a user with a seamless experience. For example, if two devices do not use the same protocol, the two devices can communicate through another device that implements protocols those two devices use. This can be in a manner that is seamless to the user, as will become more evident.

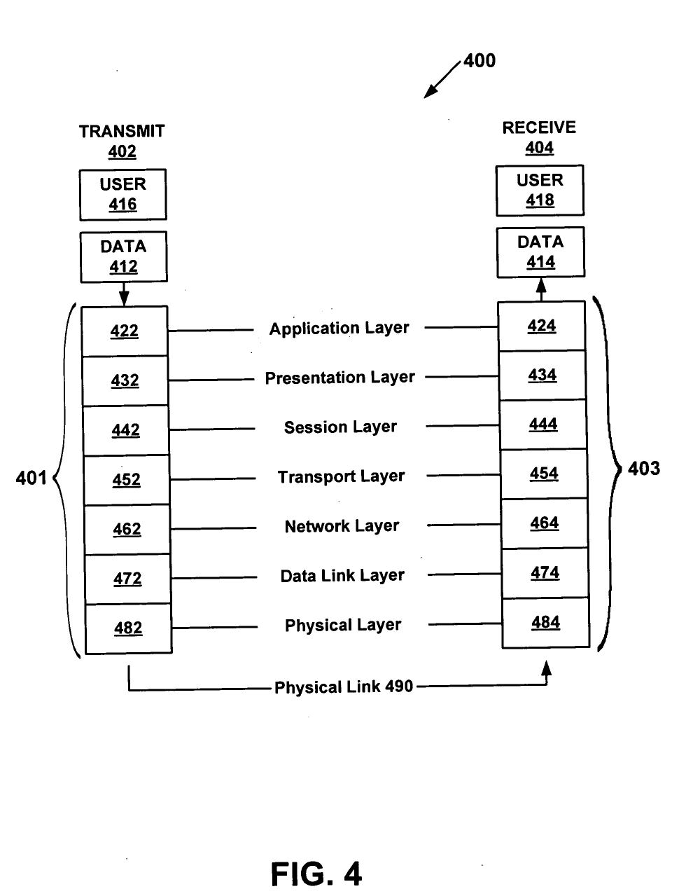

FIG. 4 is a block diagram of a system 400 that includes protocol stacks based on the open system interconnection (OSI) model on the transmitting side 402 and on the receiving side 404, according to one embodiment. FIG. 4 depicts users 416, 418 on the respective transmitting side 402 and receiving side 404. For example, the users 416 and 418 may be users of electronic devices associated with a constellation. The data 412 may be stored on user 416's electronic device.

Data 412 can be transmitted to the receiving side 404 resulting in data 414. Both sides 402, 404 include protocol stacks 401 and 403 that include layers. The respective layers are the application layers 422, 424, the presentation layers 432, 434, the session layers 442, 444, the transport layers 452, 454, the network layers 462, 464, the data link layers 472, 474, the physical layers 482, 484 and the physical link 490.

As a part of transmitting the data 412, the data is communicated down the protocol stack 401 through the layers 422, 432, 442, 452, 462, 472, 482. Then the data 412 is transmitted across the physical link 490 from the physical layer 482 associated with the transmitting side 402's protocol stack 401 to the physical layer 484 associated with the receiving side 404's protocol stack 403. Then the data 412 is communicated up the layers 484, 474, 464, 454, 444, 434, and 424 of the receiving side 404's protocol stack 403 to become data 414.

According to one embodiment, many different protocols can be used as a part of a constellation. Examples of these protocols include, among other things, wire or wireless protocols. In another example, low end blue tooth can be used, for example, on a phone. The phone may not store any media but may be capable of controlling another device. Connectivity can be provided using protocols such as Universal Serial Bus (USB), 1394, 802.11 and Ultra Wide Band (UWB). The transmit layer and session layers could use a standardized internet protocol or a proprietary protocol, such as Real File Transfer Protocol (RFTP), Real Time Clock (RTC), iPOD™ protocol, or Media Transmit Protocol™ (MTP).

According to one embodiment, the transmitting side 402 and the receiving side 404 can implement different protocols. The protocols used for the session layer, the presentation layer and the application layer can be different on the transmitting side 402 and the receiving side 404.

For example, different protocols can be used to communicate the same types of information, for example, as long as application layers with the transmitting side 402 and the receiving side 404 are able to process the information. For example, the transmitting side 402 may only implement protocol A but the receiving side 404 may implement protocol A and protocol B. If the transmitting side 402 transmits metadata for example using protocol A, the receiving side 404 will be able to extract the metadata from the packets that were transmitted from the transmitting side 402 to the receiving side 404. In another example, assume that different devices associated with a constellation implement protocol A, others implement protocol B, and some implement both protocol A and B. Metadata is an example of information and both of the protocols A and B can be implemented to communicate the metadata. Media is another example of information that can be communicated using a bridge. As will become more evident, the devices that implement protocol A and B can act as “bridges” between devices that only implement protocol A or protocol B.

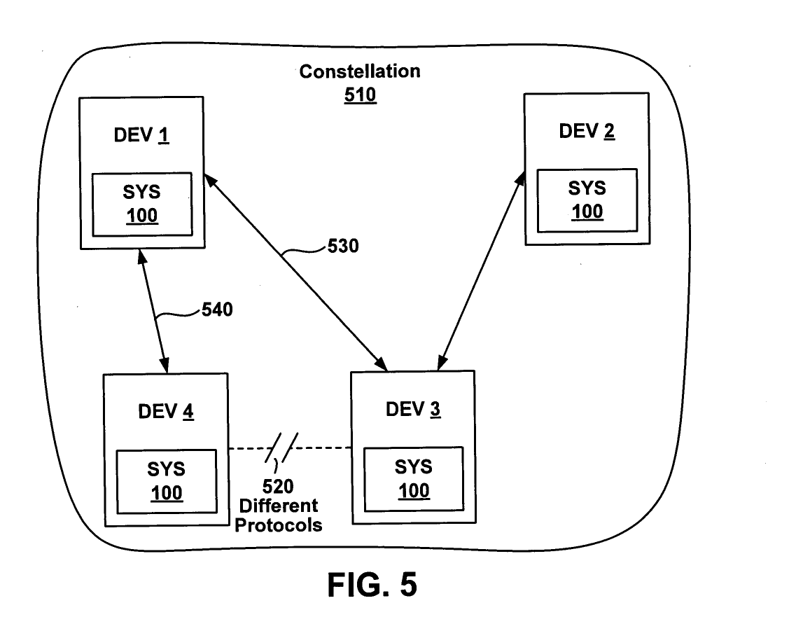

For example, FIG. 5 depicts a block diagram of a system that uses one device to bridge communications between two other devices that use different protocols, according to one embodiment. FIG. 5 depicts a constellation 510 that includes devices 14. Each device 14 includes a system 100. Device 1 can communicate with device 4 as indicated by line 540. Device 1 can also communicate with device 3 as indicated by the line 530. However, devices 3 and 4 cannot communicate as indicated by the broken line 520 because devices 3 and 4 use different protocols.

For example, device 4 may only implement protocol A and device 3 may only implement protocol B. Therefore, devices 4 and 3 may not be able to communicate directly with each other as indicated by the broken line 520. Also assume that device 1 implements both protocols A and B. Therefore, device 1 is capable of communicating with device 1 using protocol A as indicated by line 540 and is capable of communicating with device 3 using protocol B as indicated by line 530. Further assume that a user requests to navigate metadata on device 3 from device 4. In this case, the device 1 can be used as a bridge between devices 4 and 3. The metadata and media are examples of information that can be communicated between different devices even if the different devices use different protocols. According to one embodiment, a bridge is an example of a type of intermediary.

According to one embodiment, a device that serves as a bridge can intelligently filter communications between two other devices. According to yet another embodiment, a device that serves as a bridge can reformat electronic information that is communicated between two other devices. Examples of electronic information include media, a device's capabilities, state information and so on. For example, if device 3 and 4 have their metadata formatted differently, device 1 could reformat the metadata so that either device can process the other device's metadata.

### Example Computer System Environment

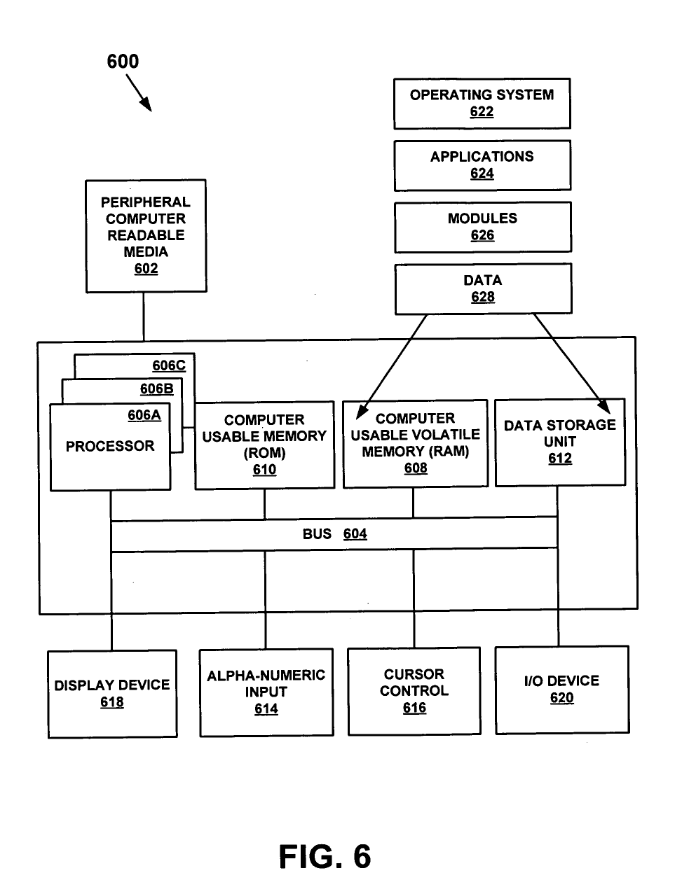

With reference now to FIG. 6, portions of the technology for enabling a plurality of devices to control each other are composed of computer-readable and computer-executable instructions that reside, for example, in computer-usable media of a computer system. That is, FIG. 6 illustrates one example of a type of computer that can be used to implement embodiments, which are discussed herein, of the present technology for enabling a plurality of devices to control each other. FIG. 6 illustrates an exemplary computer system 600 used in accordance with embodiments of the present technology for enabling a plurality of devices to control each other. It is appreciated that system 600 of FIG. 6 is exemplary only and that the present technology for enabling a plurality of devices to control each other can operate on or within a number of different computer systems including general purpose networked computer systems, embedded computer systems, routers, switches, server devices, client devices, various intermediate devices/nodes, stand alone computer systems, and the like. As shown in FIG. 6, computer system 600 of FIG. 6 is well adapted to having peripheral computer readable media 602 such as, for example, a floppy disk, a compact disc, and the like coupled thereto.

System 600 of FIG. 6 includes an address/data bus 604 for communicating information, and a processor 606A coupled to bus 604 for processing information and instructions. As depicted in FIG. 6, system 600 is also well suited to a multi-processor environment in which a plurality of processors 606A, 606B, and 606C are present. Conversely, system 600 is also well suited to having a single processor such as, for example, processor 606A. Processors 606A, 606B, and 606C may be any of various types of microprocessors. System 600 also includes data storage features such as a computer usable volatile memory 608, e.g. random access memory (RAM), coupled to bus 604 for storing information and instructions for processors 606A, 606B, and 606C. System 600 also includes computer usable non-volatile memory 610, e.g. read only memory (ROM), coupled to bus 604 for storing static information and instructions for processors 606A, 606B, and 606C. Also present in system 600 is a data storage unit 612 (e.g., a magnetic or optical disk and disk drive) coupled to bus 604 for storing information and instructions. System 600 also includes an optional alphanumeric input device 614 including alphanumeric and function keys coupled to bus 604 for communicating information and command selections to processor 606A or processors 606A, 606B, and 606C. System 600 also includes an optional cursor control device 616 coupled to bus 604 for communicating user input information and command selections to processor 606A or processors 606A, 606B, and 606C. System 600 of the present embodiment also includes an optional display device 618 coupled to bus 604 for displaying information.

Referring still to FIG. 6, optional display device 618 of FIG. 6 may be a liquid crystal device, cathode ray tube, plasma display device or other display device suitable for creating graphic images and alphanumeric characters recognizable to a user. Optional cursor control device 616 allows the computer user to dynamically signal the movement of a visible symbol (cursor) on a display screen of display device 618. Many implementations of cursor control device 616 are known in the art including a trackball, mouse, touch pad, joystick or special keys on alpha-numeric input device 614 capable of signaling movement of a given direction or manner of displacement. Alternatively, it will be appreciated that a cursor can be directed and/or activated via input from alpha-numeric input device 614 using special keys and key sequence commands. System 600 is also well suited to having a cursor directed by other means such as, for example, voice commands. System 600 also includes an I/O device 620 for coupling system 600 with external entities. For example, in one embodiment, I/O device 620 is a modem for enabling wired or wireless communications between system 600 and an external network such as, but not limited to, the Internet.

Referring still to FIG. 6, various other components are depicted for system 600. Specifically, when present, an operating system 622, applications 624, modules 626, and data 628 are shown as typically residing in one or some combination of computer usable volatile memory 608, e.g. random access memory (RAM), and data storage unit 612. In one embodiment, the present technology for enabling a plurality of devices to control each other, for example, is stored as an application 624 or module 626 in memory locations within RAM 608 and memory areas within data storage unit 612.

### Exemplary Methods of Enabling a Plurality of Devices to Control Each Other

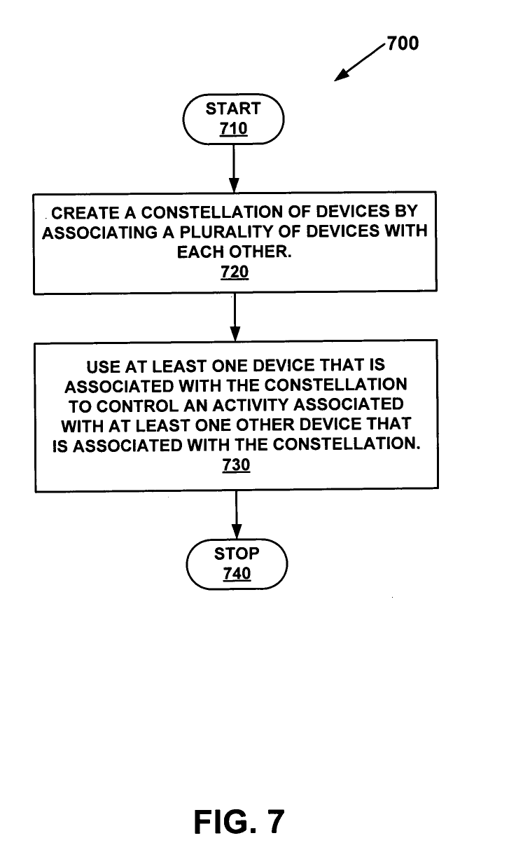

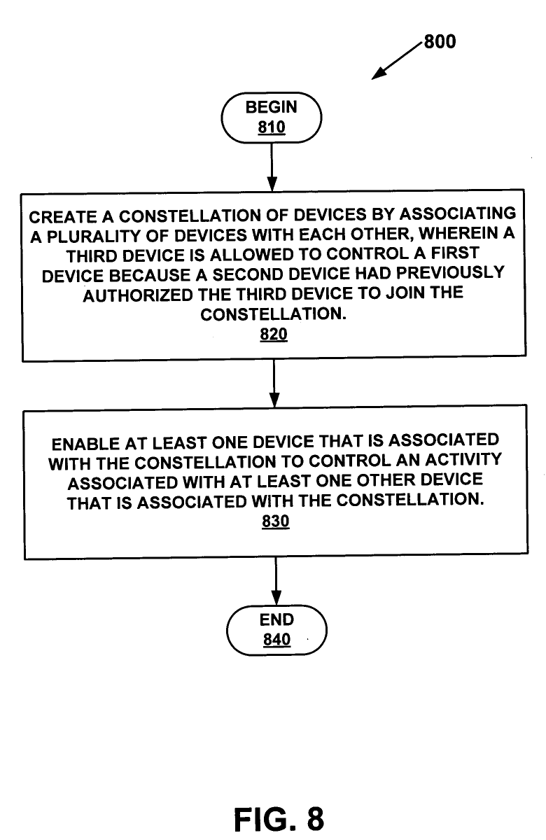

FIGS. 7 and 8 are flowcharts for methods of enabling a plurality of devices to control each other, according to various embodiments. Although specific steps are disclosed in flowcharts 700, 800, such steps are exemplary. That is, various embodiments of the present technology are well suited to performing various other steps or variations of the steps recited in flowcharts 700, 800. It is appreciated that the steps in flowcharts 700, 800 may be performed in an order different than presented, and that not all of the steps in flowcharts 700, 800 may be performed.

The computer-readable and computer-executable instructions reside, for example, in data storage features such as computer usable volatile memory 608, computer usable non-volatile memory 610, and/or data storage unit 612 of FIG. 6. The computer-readable and computer-executable instructions are used to control or operate in conjunction with, for example, processor 606A and/or processors 606A, 606B, and 606C of FIG. 6. Although specific steps are disclosed in flowcharts 700, 800, such steps are exemplary. That is, embodiments are well suited to performing various other steps or variations of the steps recited in flowcharts 700, 800. It is appreciated that the steps in flowcharts 700, 800 may be performed in an order different than presented, and that not all of the steps in flowcharts 700, 800 may be performed.

Referring to FIG. 7, in step 710, the method begins.

In step 720, a constellation of devices is created by associating a plurality of devices with each other. For example, referring to FIG. 2 the expanded constellation 210 includes devices 1, 2, and 3. Referring to FIG. 3 the constellation 310 includes devices 1-5. Referring to FIG. 5 the constellation 510 includes devices 14. According to one embodiment, a constellation of devices is created by a device that is already associated with a constellation authorizing another device. For example, referring to FIG. 2, device 1 authorized device 2 and device 2 authorized device 3. Referring to FIG. 3, devices 1 and 4 are authorized to each other, devices 1 and 3 are authorized to each other, devices 3 and 2 are authorized to each other, and devices 3 and 5 are authorized to each other and so on.

An authorizer associated with a device maintains a list of what devices it has authorized, according to one embodiment. For example, referring to FIG. 3 an authorizer 110 associated with device 1 could maintain a list that indicates devices 3 and 4 were authorized by device 1. In another example, an authorizer 110 associated with device 4 can maintain a list that indicates device 1 was authorized by device 4. In another example, the authorizer 110 associated with device 3 could maintain a list that indicates device 1, 2 and 5 were authorized by device 3. In yet another example, device 2 could maintain a list indicating that device 3 was authorized by device 2 and so on with each of the devices depicted in FIG. 3.

In step 730, at least one device that is associated with the constellation is used to control an activity associated with at least one other device that is associated with the constellation. For example referring to FIG. 3, assume that a user uses device 2 to display the titles of songs and the artists for those songs that are stored on device 5. The songs are an example of media. The titles and the artists are examples of metadata. Displaying the metadata is an example of an activity, according to one embodiment. Causing a device to display metadata is an example of control, according to another embodiment.

Still referring to FIG. 3, assume for the sake of illustration that although the song is stored on device 5, device 4 is a high end stereo system. Therefore, for the sake of illustration assume that the user wants to use device 2 to cause device 4 to play a particular song that is stored on device 5. In this case, play is an example of an activity that can be controlled, for example, using a play command associated with a set of controls. The media may be transferred from device 5 to device 4, for example, through device 3 and device 1. Transferring the song is another example of an activity that can be controlled using, for example, a sync command associated with a set of controls.

In step 740, the method stops.

Referring to FIG. 8 in step 810, the method begins.

In step 820, a constellation of devices is created by associating a plurality of devices with each other, wherein a third device is allowed to control a first device because a second device had previously authorized the third device to join the constellation. For example, referring to FIG. 2, assume that the authorizer 110 associated with device 1 authorized device 2 to join the constellation or vice versa. Further assume for the sake of illustration that device 2's authorizer 110 authorized device 3 to join the constellation.

In step 830, at least one device that is associated with the constellation is enabled to control an activity associated with at least one other device that is associated with the constellation. For example still referring to FIG. 2, the user may decide that they want to use device 3 to control device 1 in some manner. In this case, for example, device 3 can connect with device 1 as indicated by line 233. Assume for the sake of illustration that device 1 does not have any information indicating that device 3 belongs to the constellation. According to one embodiment, device 1 can ask the other devices, such as device 2, which belong to the constellation whether they have information indicating device 3 has been previously authorized. In this case, device 2 can respond indicating that it has previously authorized device 3.

Then, according to one embodiment, device 1 can allow device 3 to control it (i.e., device 1) in some respect. According to another embodiment, any device associated with the expanded constellation 210 can control any other device associated with the expanded constellation 210. For example, device 1 can control devices 2 and 3, device 2 can control devices 1 and 3, and device 3 can control devices 1 and 2.

In step 840, the method ends.

The following are a few more examples of a device that is associated with a constellation controlling another device associated with a constellation. For example, a cell phone could be used to cause a land line phone to make a call. In another example, a phone may be used to cause a fax machine to fax something.

In a third example, a user may connect the PMP to their PC using a USB or a wireless connection. The user can select a song on the PMP causing the song to be played by Media Player™ software on the PC. For example, according to one embodiment, the song is transmitted from the PMP to the PC in order to play it. The user can use a subset of controls associated with their PMP to pause, fast forward, rewind, or skip songs that are on the PC.

In a fourth example, a user may connect their PMP to their PC. The user can then use their PMP to determine what media is on the PC as well as what is on the PMP. The user can select a song, which may be on either the PMP or the PC, to be played on the PC. If the song was on the PMP, according to one embodiment, the song can be transmitted to the PC.

In a fifth example, media or metadata can be communicated from any device associated with a constellation to any other device associated with the constellation. The media or metadata can be, according to one embodiment, broadcast from one device to all of the other devices, which are capable of receiving the media or metadata, in the constellation. Intermediaries and bridges can be used as a part of broadcasting media or metadata from one device to all of the other devices in a constellation. In another example, a centralized server can be used as a part of transmitting media or metadata between devices in a constellation.

In a sixth example, a user can use their car stereo to choose media on their PMP. As the music is playing on the car stereo, the user can click “next” on the car stereo or on the PMP to advance to the next track. According to one embodiment, if another device connects to the car stereo, it can cause a different piece of media to be played on the car stereo. According to another embodiment, the user can still use either the PMP or the car stereo to control each other or other devices in the constellation. The user can see the station identifier and the frequency on the PMP. The user can use their PMP to record broadcast music played on the car stereo.

In a seventh example, media that is being “played” on two different devices at the same time can be synchronized.

### CONCLUSION

According to various embodiments, a plurality of devices are enabled to control each other. According to various embodiments, using one device to control one or more other devices is a seamless experience for a user. For example referring to FIG. 3 as described herein, a user can use device 2 to play a song on device 4 where the song was originally stored on device 5. The “focus” can move from device to device. According to one embodiment, “focus” is defined as referencing which ever device associated with a constellation the user is currently interacting with. For example, the “focus” may be at which ever device the user is closest to. If the user is close to a device that plays audio media, the user can hear that device play audio media. If the user is close to a device that plays audio visual media, the user can hear and see the device play audio visual media. In another example, if the user presses “pause” on a given device, the control may only be sent to the device which is in relatively close proximity to the user. More specifically, if the user presses “pause” on a remote control that works with multiple TV screens, the TV that is closest will be paused. In yet another example, “focus” can enable the user to easily navigate metadata on device 5 and to select a song to be played on device 4.

As can be seen, various embodiments of the present invention can be used to create a constellation of devices, which potentially use different protocols, to control the state of the devices associated with the constellation. Further, various embodiments provide a distributed state model where the states of devices are communicated between distributed devices. Further, a distributed model is used for controlling devices associated with the constellation. According to various embodiments, trust relationships are created between various devices associated with a constellation, for example, through authorization as described herein. For example, a device that is trusted by another device can control the later device.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of enabling a plurality of devices to control each other, the method comprising:
creating a constellation of devices by associating the plurality of devices with each other; and
using at least one device that is associated with the constellation to control an activity associated with at least one other device that is associated with the constellation.

2. The computer-implemented method of claim 1, wherein the using of the at least one device that is associated with the constellation to control the activity associated with the at least one other device that is associated with the constellation further comprises:
using the at least one device that is associated with the constellation to access media associated with the at least one other device that is associated with the constellation.

3. The computer-implemented method of claim 1, wherein the using of the at least one device that is associated with the constellation to control the activity associated with the at least one other device that is associated with the constellation further comprises:
enabling the at least one device that is associated with the constellation to navigate metadata associated with the at least one other device that is associated with the constellation.

4. The computer-implemented method of claim 1, wherein the using of the at least one device that is associated with the constellation to control the activity associated with the at least one other device that is associated with the constellation further comprises:
transmitting media between the at least one device that is associated with the constellation and the at least one other device that is associated with the constellation.

5. The computer-implemented method of claim 1, wherein the using of the at least one device that is associated with the constellation to control the activity associated with the at least one other device that is associated with the constellation further comprises:
providing the at least one device that is associated with the constellation with control of the at least one other device that is associated with the constellation without requiring at least one of the devices to store media.

6. The computer-implemented method of claim 5, wherein the using of the at least one device that is associated with the constellation to control the activity associated with the at least one other device that is associated with the constellation further comprises:
enabling the controlling device to use a keypad associated with the controlling device to control the at least one other device.

7. A system that enables a plurality of devices to control each other, the system comprising:
an authorizer associated with a first device that is associated with a constellation for authorizing devices to join the constellation; and
a control enabler coupled to the authorizer, the control enabler for enabling the first device to control an activity associated with at least one other device associated with the constellation.

8. The system of claim 7, wherein the system uses a constellation control protocol and wherein the constellation control protocol includes a set of controls that enables devices associated with the constellation to implement a different subset of the set of controls.

9. The system of claim 8, wherein a subset of the controls for a particular device is based upon the particular device's capabilities and on how the manufacturer chose to implement the particular device.

10. The system of claim 8, wherein a new control can be added to the subset of the controls that the particular device is capable of.

11. The system of claim 8, wherein the set of controls includes display, play, pause, stop, sync, next, skip, shuffle, fast forward, rewind, increase volume and decrease volume.

12. The system of claim 7, wherein the authorizer uses a type of device authorization that is selected from a group consisting of a particular device being re-authorized each time the particular device requests to control another device associated with the constellation and the particular device being perpetually authorized after the particular device has been authorized to join the constellation.

13. The system of claim 7, further comprising a metadata communicator for communicating the first device's metadata to another device associated with the constellation.

14. The system of claim 13, wherein the first device's metadata includes the first device's capabilities, description of media stored on the first device, and one or more artists of the media stored on the first device.

15. The system of claim 7, wherein the authorizer maintains a list of what devices the first device has authorized and wherein the system is capable of communicating information about a particular device that the first device has authorized to another device associated with the constellation.

16. The system of claim 7, wherein the first device associated with the constellation can be selected from a group consisting of a computer, a television, a portable media player, a phone, and a stereo.

17. Computer-readable instructions stored on a computer-usable medium wherein the computer-readable instructions when executed cause a computer system to perform a method of enabling a plurality of devices to control each other, the method comprising:
creating a constellation of devices by associating a plurality of devices with each other, wherein a third device is allowed to control a first device because a second device had previously authorized the third device to join the constellation; and
enabling at least one device that is associated with the constellation to control an activity associated with at least one other device that is associated with the constellation.

18. The computer-readable instructions of claim 17 wherein the computer-readable instructions further cause said computer system to perform a method comprising:
discovering the third device's capabilities as a part of authorizing the third device to join the constellation.

19. The computer-readable instructions of claim 17 wherein the computer-readable instructions further cause said computer system to perform a method comprising:
communicating the third device's capabilities to another device associated with the constellation.

20. The computer-readable instructions of claim 17 wherein the computer-readable instructions further cause said computer system to perform a method comprising:
using the second device to bridge communications between the first and the third devices, wherein the first and third devices use different protocols and the second device uses both of the protocols that the first and the third devices use.
